(19) United States
(12) Patent Application Publication
(10) Pub. No.: US 2008/0265108 A1
(43) Pub. Date: Oct. 30, 2008

(54) STAND

(76) Inventor: Mauro Felici, Chelsea Heights (AU)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 12/110,954

(22) Filed: Apr. 28, 2008

Related U.S. Application Data
(60) Provisional application No. 60/926,534, filed on Apr. 27, 2007.

(51) Int. Cl. F16M 11/00

(52) U.S. Cl. 248/127

(57) ABSTRACT

A stand for attaching a bowl to a surface. The stand includes a base with a first continuous side wall extends from a first surface of the base to define a first suction cup. A second continuous side wall extends from a second surface of the base to define a second suction cup. The second suction cup extends in an opposing direction from the first suction cup. The first continuous side wall includes an inner face extending between the base and a first outer rim. The inner face has a first continuous raised ridge for defining a first cavity within the first continuous side wall for securing the stand to one of the bowl and the surface. A handle can be provided for releasing the stand from one of the bowl and the surface.

### CROSS-REFERENCE TO RELATED APPLICATIONS

The subject patent application claims priority to and all the benefits of U.S. Provisional Patent Application Ser. No. 60/926,534, which was filed on Apr. 27, 2007.

### BACKGROUND OF THE INVENTION

1. Field of the Invention

The present invention relates to a stand for attaching a bowl to a surface.

2. Description of Related Art

Stands having a suction cup on their underside for receiving a bowl are known. Such stands however tend to be relatively flexible and also do not provide a high degree of suction between the bowl and the stand. The present invention seeks to overcome the problems of the prior art.

### SUMMARY OF THE INVENTION AND ADVANTAGES

The present invention provides a stand for attaching a bowl to a surface. The stand comprises a base having a first surface and an opposing second surface. The first continuous side wall extends from the first surface of the base to a first outer rim to define a first suction cup. A second continuous side wall extends from the second surface of the base to a second outer rim to define a second suction cup. The second suction cup extends in an opposing direction from the first suction cup. The first continuous side wall includes an inner face extending between the base and the first outer rim with the inner face having a first continuous raised ridge for defining a first cavity within the first continuous side wall for securing the stand to one of the bowl and the surface.

The present invention can also include a handle extending from an outer face of the first continuous side wall for releasing the stand from one of the bowl and the surface.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a side view of the stand in use;

FIG. 2 is a perspective view of the stand in accordance with the subject invention;

FIG. 3 is a side view of the stand; and

FIG. 4 is a cross-sectional side view of the stand.

### DETAILED DESCRIPTION OF THE INVENTION

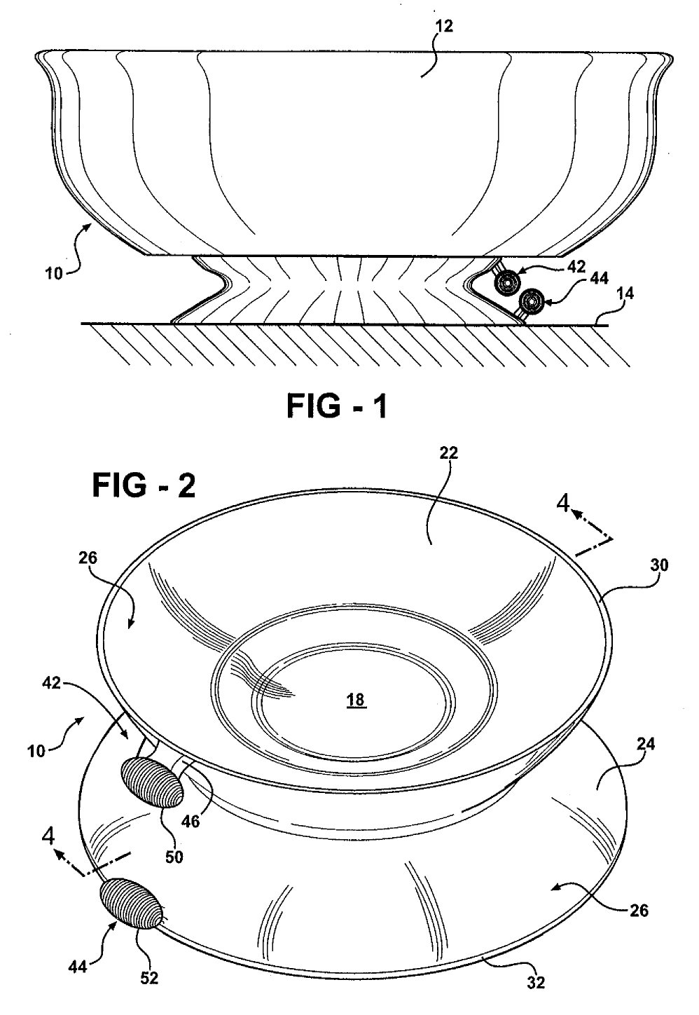

Referring to the Figures, wherein like numerals indicate like or corresponding parts throughout the several views, a stand is generally shown at 10 in FIGS. 1 and 2. As illustrated, the stand 10 is capable of attaching a bowl 12, or other device, to a surface 14, such as a kitchen counter. As will be appreciated, the stand 10 is capable of securing any number of items to any suitable surface.

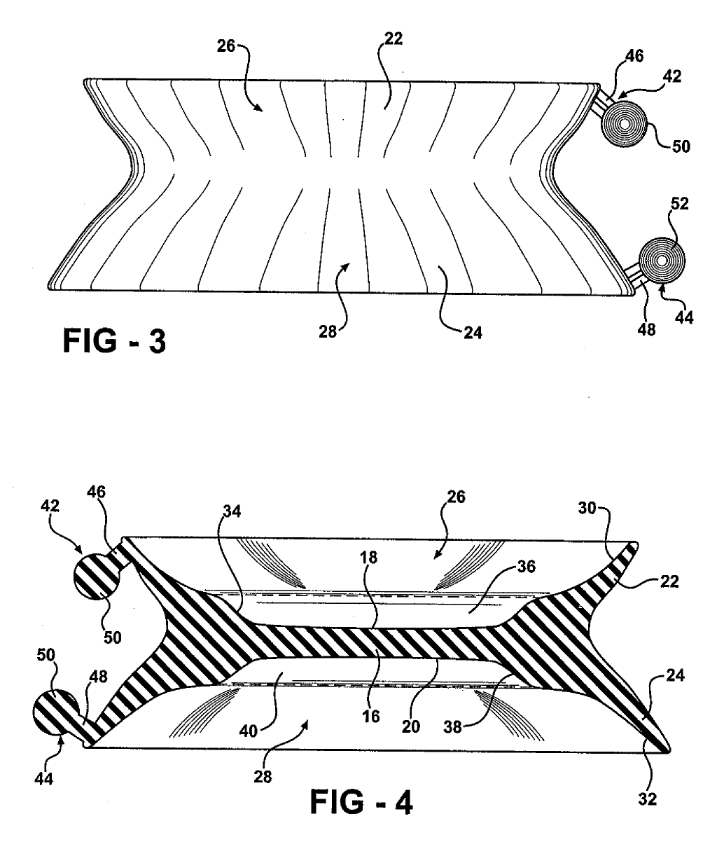

Referring to FIGS. 1-4, the stand 10 includes a base 16 having a first surface 18 and an opposing second surface 20. Extending from the base 16 are first 22 and second 24 continuous side walls defining back-to-back first 26 and second 28 suction cups. Specifically, the first continuous side wall 22 extends from the first surface 18 of the base 16 to a first outer rim 30 to define the first suction cup 26. Similarly, the second continuous side wall 24 extends from the second surface 20 of the base 16 to a second outer rim 32 to define the second suction cup 28. The second suction cup 28 extends in an opposing direction from the first suction cup 26. As can be seen, the first suction cup 26 is larger than the second suction cup 28. Specifically, the first outer rim 30 of the first suction cup 26 has a larger diameter than the second outer rim 32 of the second suction cup 28. Although not required, the suction cups 26,28 are preferably circular, which is particularly suitable for receiving circular bowls. In alternative embodiments, other shapes are possible. For example, a mouth of one or both of the suction cups 26,28 can be elliptical, square or rectangular.

A width of each of the first 30 and second 32 outer rims is thinner than a width of the base 16. Preferably, the first 22 and second 24 side walls taper inwardly from the base 16 toward the outer rims 30, 32.

As best shown in FIG. 4, the first continuous side wall 22 includes an inner face extending between the base 16 and the first outer rim 30 with the inner face having a first continuous raised ridge 34. The first continuous raised ridge 34 extends around the first side wall 22 for defining a first cavity 36 within the first continuous side wall 22 for securing the stand 10 to one of the bowl 12 and the surface 14. Similarly, the second continuous side wall 24 includes an inner face extending between the base 16 and the second continuous rim 32 with the inner face of the second continuous side wall 24 having a second continuous raised ridge 38 for defining a second cavity 40 in opposing relationship to the first cavity 36 for securing the stand 10 to the other of the bowl 12 and the surface 14. The first continuous side wall 22 also includes an outer face opposing the inner face of the first continuous side wall 22. Similarly, the second continuous side wall 24 also includes an outer face opposing the inner face of the second continuous side wall 24. Alternatively, only one of the two suction cups 26,28 could include the raised ridge 34,38. This suction cup 26,28 would preferably be used to receive the bowl 12. The remaining suction cup 26,28 lacking the raised ridge 34,38 would be used to secure the stand 10 to the surface 14.

Preferably, at least a portion of the base 16 and the first continuous side wall 22 are formed of an integral homogenous material. Similarly, preferably at least a portion of the base 16 and the second continuous side wall 24 are formed of an integral homogenous material. In the most preferred embodiment, the base 16 and the first 22 and second 24 continuous side walls are formed of an integral homogenous material. Although many materials are suitable, the material should be an elastically deformable material, such as silicone rubber. This type of elastic material provides the necessary grip and can be pressed down easily. Further, this type of material can mold itself to the shape of surface 14 and the bowl 12 for facilitating the necessary suction. Preferably, the silicone used is non-porous, does not retain odors and can withstand high temperatures.

The stand 10 also includes a first handle 42 extending from the outer face of the first continuous side wall 22 for releasing the stand 10 from one of the bowl 12 and the surface 14. In the preferred embodiment, the stand 10 also includes a second handle 44 extending from the outer face of the second continuous side wall 24 for releasing the stand 10 from the other of the bowl 12 and the surface 14. As shown, the handles 42,44 are aligned vertically for providing simultaneous actuation of the handles 42,44. Also, the handles 42,44 are shown as extending from the first 22 and second 24 continuous side walls adjacent the outer rims 30,32. It should be appreciated that the handles 42,44 can be located on the stand 10 in any suitable position and orientation. Further, the stand 10 may only include one handle 42,44 extending from one of the suction cups 26,28.

The preferred configuration of the handles 42,44 include a shaft 46,48 having first and second opposing ends with the first end mounted to the associated side wall 22,24. A bulbous member 50,52 is mounted to the second end of the shaft 48. Preferably, the shaft 46,48 and the bulbous member 50,52 are formed of an integral homogenous material. Even more preferably, at least a portion of the base 16, the first continuous side wall 22 and the first 42 handle are formed of an integral homogenous material. In the most preferred embodiment, the base 16, the first 22 and second 24 continuous side walls and both of the handles 42,44 are formed of an integral homogenous material. As discussed above, the material is preferably an elastically deformable material, such as silicone rubber.

In use, one of the suction cups 26,28 is pressed onto the surface 14. Suction between the surface 14 and suction cup 26,28 keeps the stand 10 in place. As the outer rim 30,32 of the side wall 22,24 of the suction cup 26,28 is relatively thin, the outer rim 30,32 is able to deform on contact with the surface 14 ensuring a better contact between suction cup 26,28 and surface 140 and maintaining a vacuum within the suction cup 26,28.

Once the stand 10 is in place, a bowl 12, or other suitable device, is placed onto the remaining suction cup 26,28. A side and/or bottom of the bowl 12 abuts the raised ridge 34,38 dividing the volume of the suction cup 26,28 into two parts. An upper part of the side wall 22,24 of the suction cup 26,28 grips the bowl 12, keeping the bowl 12 in place. A lower part of the side wall 22,24 below the raised ridge 34,38 defines the cavity 36,40. The separation of the upper and lower parts of the side walls 22,24 is shown schematically in FIG. 4 by a phantom line. The small amount of air within the cavity 36,40 keeps the bowl 12 in place. In addition, the raised ridge 34,38 improves the structural stability of the stand 10.

In order to remove the stand 10 from the surface 14, a user pulls one or both of the handles 42,44. This deforms the suction cup(s) 26,28 slightly to break the seal between stand 10 and the surface 14 or bowl 12, which allows the stand 10 to be removed. Similarly, to remove the stand 10 from both the surface 14 and the bowl 12 at the same time, a user can squeeze the handles 42,44 together deforming both suction cups 26,28 and simultaneously breaking the seals between bowl 12 and one of the cups 26,28 and the surface 14 and the other cup 26,28.

Each of the suction cups 26,28 may support and hold a bowl 12 or may anchor the stand 10 to the surface 14. The choice of which acts as the suction cup 26,28 receiving the bowl 12 depends upon the size of the bowl 12. Typically one chooses the cup 26,28 having a slightly smaller diameter than a diameter of a bottom of the bowl 12 to ensure the best fit between cup 26,28 and bowl 12. This dual functionality of the two suction cups 26,28 provides the stand 10 according to the invention with an additional degree of flexibility. The stand 10 according to the invention finds particular application in kitchens. In particular, the stand 10 can be used to grip mixing bowls.

The invention has been described in an illustrative manner, and it is to be understood that the terminology which has been used is intended to be in the nature of words of description rather than of limitation. As is now apparent to those skilled in the art, many modifications and variations of the present invention are possible in light of the above teachings. It is, therefore, to be understood that within the scope of the appended claims the invention may be practiced otherwise than as specifically described.

What is claimed is:

1. A stand for attaching a bowl to a surface, said stand comprising:
a base having a first surface and an opposing second surface;
a first continuous side wall extending from said first surface of said base to a first outer rim to define a first suction cup;
a second continuous side wall extending from said second surface of said base to a second outer rim to define a second suction cup extending in an opposing direction from said first suction cup; and
said first continuous side wall including an inner face extending between said base and said first outer rim with said inner face having a first continuous raised ridge for defining a first cavity within said first continuous side wall for securing said stand to one of the bowl and the surface.

2. A stand as set forth in claim 1 wherein said second continuous side wall includes an inner face extending between said base and said second continuous rim with said inner face of said second continuous side wall having a second continuous raised ridge for defining a second cavity in opposing relationship to said first cavity for securing said stand to the other of the bowl and the surface.

3. A stand as set forth in claim 1 wherein said first outer rim of said first suction cup has a larger diameter than said second outer rim of said second suction cup.

4. A stand as set forth in claim 1 wherein at least a portion of said base and said first continuous side wall are formed of an integral homogenous material.

5. A stand as set forth in claim 4 wherein at least a portion of said base and said second continuous side wall are formed of an integral homogenous material.

6. A stand as set forth in claim 5 wherein said base and said first and second continuous side walls are formed of an integral homogenous material.

7. A stand as set forth in claim 1 wherein said first continuous side wall includes an outer face opposing said inner face of said first continuous side wall and further including a first handle extending from said outer face of said first continuous side wall for releasing said stand from one of the bowl and the surface.

8. A stand as set forth in claim 7 wherein said second continuous side wall includes an outer face opposing said inner face of said second continuous side wall and further including a second handle extending from said outer face of said second continuous side wall for releasing said stand from the other of the bowl and the surface.

9. A stand as set forth in claims 1 wherein a width of each of said first and second outer rims are thinner than a width of said base.

10. A stand for attaching a bowl to a surface, said stand comprising:
a base having a first surface and an opposing second surface;
a first continuous side wall extending from said first surface of said base to a first outer rim to define a first suction cup for securing said stand to one of the bowl and the surface with said first continuous side wall having an inner face and an outer face opposing said inner face;
a second continuous side wall extending from said second surface of said base to a second outer rim to define a second suction cup extending in an opposing direction from said first suction cup for securing said stand to the other the bowl and the surface with said second continuous side wall having an inner face and an outer face opposing said inner face; and
a handle extending from said outer face of said first continuous side wall for releasing said stand from one of the bowl and the surface.

11. A stand as set forth in claim 10 further including a second handle extending from said outer face of said second continuous side wall for releasing said stand from the other of the bowl and the surface.

12. A stand as set forth in claim 11 wherein said handles are aligned vertically for providing simultaneous actuation of said handles.

13. A stand as set forth in claim 10 wherein said handle includes a shaft having first and second opposing ends with said first end mounted to said first continuous side wall.

14. A stand as set forth in claim 13 further including a bulbous member mounted to said second end of said shaft.

15. A stand as set forth in claim 14 wherein said shaft and said bulbous member are formed of an integral homogenous material.

16. A stand as set forth in claim 10 wherein at least a portion of said base, said first continuous side wall and said handle are formed of an integral homogenous material.

17. A stand as set forth in claim 11 wherein said base, said first and second continuous side walls and said handles are formed of an integral homogenous material.

18. A stand as set forth in claim 10 wherein said first continuous side wall includes an inner face extending between said base and said first outer rim with said inner face having a continuous raised ridge for defining a first cavity within said first continuous side wall for securing said stand to one of the bowl and the surface.

19. A stand as set forth in claim 18 wherein said second continuous side wall includes an inner face having a continuous raised ridge for defining a second cavity in opposing relationship to said first cavity for securing said stand to the other of the bowl and the surface.
